(19) United States
(12) Patent Application Publication
(10) Pub. No.: US 2007/0242611 A1
(43) Pub. Date: Oct. 18, 2007

(54) Computer Hardware Fault Diagnosis

(76) Inventors: Charles J. Archer, Rochester, MN (US); Mark G. Megerian, Rochester, MN (US); Joseph D. Ratterman, Rochester, MN (US); Brian E. Smith, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/279,573

(22) Filed: Apr. 13, 2006

(51) Int. Cl. H04J 3/14; H04J 1/16

(52) U.S. Cl. 370/242

(57) ABSTRACT

Methods, apparatus, and computer program products are disclosed for computer hardware fault diagnosis carried out in a parallel computer, where the parallel computer includes a plurality of compute nodes. The compute nodes are coupled for data communications by at least two independent data communications networks, where each data communications network includes data communications links among the compute nodes. Typical embodiments carry out hardware fault diagnosis by executing a collective operation through a first data communications network upon a plurality of the compute nodes of the computer, executing the same collective operation through a second data communications network upon the same plurality of the compute nodes of the computer, and comparing results of the collective operations.

### GOVERNMENT RIGHTS IN INVENTION

The U.S. Government has a paid-up license in this invention and the right in limited circumstances to require the patent owner to license others on reasonable terms as provided for by the terms of Contract No. B519700 awarded by the Department of Energy.

### BACKGROUND OF THE INVENTION

1. Field of the Invention

The field of the invention is data processing, or, more specifically, methods, systems, and products for computer hardware fault diagnosis in a parallel computer.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Parallel computing is an area of computer technology that has experienced advances. Parallel computing is the simultaneous execution of the same task (split up and specially adapted) on multiple processors in order to obtain results faster. Parallel computing is based on the fact that the process of solving a problem usually can be divided into smaller tasks, which may be carried out simultaneously with some coordination.

Parallel computers execute parallel algorithms. A parallel algorithm can be split up to be executed a piece at a time on many different processing devices, and then put back together again at the end to get a data processing result. Some algorithms are easy to divide up into pieces. Splitting up the job of checking all of the numbers from one to a hundred thousand to see which are primes could be done, for example, by assigning a subset of the numbers to each available processor, and then putting the list of positive results back together. In this specification, the multiple processing devices that execute the individual pieces of a parallel program are referred to as ‘compute nodes.’ A parallel computer is composed of compute nodes and other processing nodes as well, including, for example, input/output (‘I/O’) nodes, and service nodes.

Parallel algorithms are valuable because it is faster to perform some kinds of large computing tasks via a parallel algorithm than it is via a serial (non-parallel) algorithm, because of the way modern processors work. It is far more difficult to construct a computer with a single fast processor than one with many slow processors with the same throughput. There are also certain theoretical limits to the potential speed of serial processors. On the other hand, every parallel algorithm has a serial part and so parallel algorithms have a saturation point. After that point adding more processors does not yield any more throughput but only increases the overhead and cost.

Parallel algorithms are designed also to optimize data communications requirements among the nodes of a parallel computer. There are two ways parallel processors communicate, shared memory or message passing. Shared memory processing needs additional locking for the data and imposes the overhead of additional processor and bus cycles and also serializes some portion of the algorithm.

Message passing processing uses high-speed data communications networks and message buffers, but this communication adds transfer overhead on the data communications networks as well as additional memory need for message buffers and latency in the data communications among nodes. Designs of parallel computers use specially designed data communications links so that the communication overhead will be small but it is the parallel algorithm that decides the volume of the traffic.

Many data communications network architectures are used for message passing among nodes in parallel computers. Compute nodes may be organized in a network as a ‘torus’ or ‘mesh,’ for example. Also, compute nodes may be organized in a network as a tree. A torus network connects the nodes in a three-dimensional mesh with wrap around links. Every node is connected to its six neighbors through this torus network, and each node is addressed by its x,y,z coordinate in the mesh. In a tree network, the nodes typically are connected into a binary tree: each node has a parent, and two children (although some nodes may only have zero or one child, depending on the hardware configuration). In computers that use a torus and a tree network, the two networks typically are implemented independently of one another, with separate routing circuits, separate physical links, and separate message buffers.

A torus network lends itself to point to point geometrically aware diagnostics, but a tree network typically is inefficient in point to point communication. A tree network, however, does provide high bandwidth and low latency for certain collective operations, message passing operations where all compute nodes participate simultaneously. Because thousands of nodes may participate in a collective operation, hardware fault diagnosis in such computers is very difficult.

In addition, many collective operations may include calculations as part of a collective message passing operation—thus making it even more difficult to distinguish whether a fault is a fault in a data communications link or a fault in a processor, a coprocessor, or an arithmetic logic unit (‘ALU’).

### SUMMARY OF THE INVENTION

Methods, apparatus, and computer program products are disclosed for computer hardware fault diagnosis carried out in a parallel computer, where the parallel computer includes a plurality of compute nodes. The compute nodes are coupled for data communications by at least two independent data communications networks, where each data communications network includes data communications links among the compute nodes. Typical embodiments carry out hardware fault diagnosis by executing a collective operation through a first data communications network upon a plurality of the compute nodes of the computer, executing the same collective operation through a second data communications network upon the same plurality of the compute nodes of the computer, and comparing results of the collective operations.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an exemplary system for computer hardware fault diagnosis according to embodiments of the present invention.

FIG. 2 sets forth a block diagram of an exemplary compute node useful in compute hardware fault diagnosis according to embodiments of the present invention.

FIG. 3A illustrates an exemplary Point To Point Adapter useful in systems that diagnose hardware faults according to embodiments of the present invention.

FIG. 3B illustrates an exemplary Collective Operations Adapter useful in systems that diagnose hardware faults according to embodiments of the present invention.

FIG. 4 illustrates an exemplary data communications network optimized for point to point operations.

FIG. 5 illustrates an exemplary data communications network optimized for collective operations.

FIG. 6 sets forth a flow chart illustrating an exemplary method of computer hardware fault diagnosis according to embodiments of the present invention.

FIG. 7 sets forth a flow chart illustrating a further exemplary method of computer hardware fault diagnosis according to embodiments of the present invention.

FIG. 8 sets forth a flow chart illustrating a further exemplary method of computer hardware fault diagnosis according to embodiments of the present invention.

FIG. 9 sets forth a flow chart illustrating a further exemplary method of computer hardware fault diagnosis according to embodiments of the present invention.

### DETAILED DESCRIPTION OF EXEMPLARY EMBODIMENTS

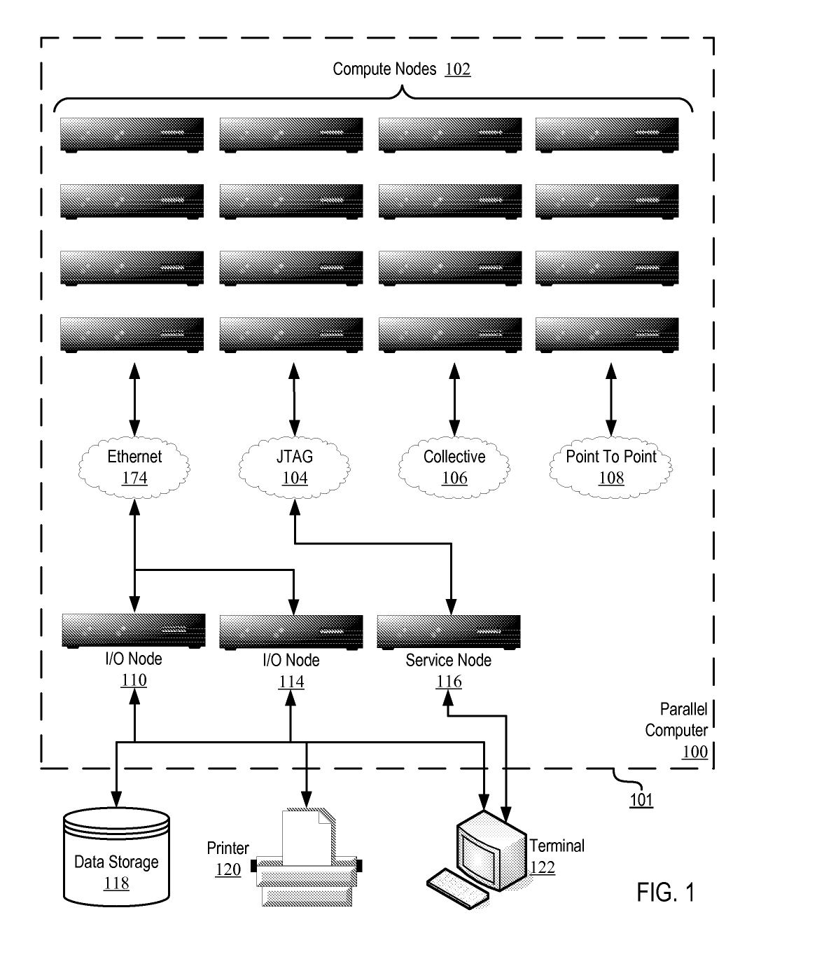

Exemplary methods, apparatus, and computer program products for computer hardware fault diagnosis according to embodiments of the present invention are described with reference to the accompanying drawings, beginning with FIG. 1.

FIG. 1 illustrates an exemplary system for computer hardware fault diagnosis according to embodiments of the present invention. The system of FIG. 1 includes a parallel computer (100), non-volatile memory for the computer in the form of data storage device (118), an output device for the computer in the form of printer (120), and an input/output device for the computer in the form of computer terminal (122).

Parallel computer (100) in the example of FIG. 1 includes a plurality of compute nodes (102). The compute nodes (102) are coupled for data communications by several independent data communications networks including a high speed Ethernet network (174), a Joint Test Action Group (‘JTAG’) network (104), a collective operations network (106), and a point to point operations network (108). As described in more detail below, each data communications network is implemented with data communications links among the compute nodes (102). In addition to compute nodes, computer (100) includes input/output (‘I/O’) nodes (110, 114) coupled to compute nodes (102) through one of the data communications networks (174). The I/O nodes (110, 114) provide I/O services between compute nodes (102) and I/O devices (118, 120, 122). The computer (100) also includes a service node (116) coupled to the compute nodes through one of the networks (104). The service node (116) provides service common to pluralities of compute nodes, loading programs into the compute nodes, starting program execution on the compute nodes, retrieving results of program operations on the computer nodes, and so on.

The system of FIG. 1 operates generally to carry out computer hardware fault diagnosis according to embodiments of the present invention by executing a collective operation through a first data communications network (106) upon a plurality of compute nodes (102) of parallel computer (100), executing the same collective operation through a second data communications network (108) upon the same plurality of the compute nodes of the computer, and comparing results of the collective operations. A collective operation is an operation, a message-passing computer program instruction, that is executed simultaneously, that is, at approximately the same time, by all the compute nodes in a ‘plurality’ or ‘group’ of compute nodes. Such a plurality or group of compute nodes may include all the compute nodes (102) in the parallel computer (100) or a subset all the compute nodes. In MPI terminology, such a ‘plurality’ or ‘group’ may be defined as a ‘communicator. ’

Collective operations are composed of many point to point messages executed more or less concurrently (depending on the operation and the internal algorithm) and involve all processes running in a given group of compute nodes, that is, in a given MPI communicator. Every process on every compute node in the group must call or execute the same collective operation at approximately the same time. The required simultaneity is described as approximate because many processes running on many separate, physical compute node cannot be said to do anything all together at exactly the same time. Parallel communications libraries provide functions to support synchronization. In the MPI example, such a synchronization function is a ‘barrier’ routine. To synchronize, all processes on all compute nodes in a group call MPI_barrier( ), for example, and then all processes wait until all processes reach the same point in execution. Then execution continues, with substantial synchronization.

Most of the collective operations are variations and/or combinations of four basic operations: broadcast, gather, scatter and reduce. In a broadcast operation, all processes specify the same root process, whose buffer contents will be sent. Processes other than the root specify receive buffers. After the operation, all buffers contain the message from the root process.

A scatter operation, like the broadcast operation, is also a one-to-many collective operation. All processes specify the same receive count. The send arguments are only significant to the root process, whose buffer actually contains sendcount * N elements of a given datatype, where N is the number of processes in the given group of compute nodes. The send buffer will be divided equally and dispersed to all processes (including itself). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gather from the ranked compute nodes into a receive buffer in a root node.

A reduce operation is also a many-to-one collective operation that includes an arithmetic or logical function performed on two data elements. All processes specify the same ‘count’ and the same arithmetic or logical function. After the reduction, all processes have sent count data elements from compute node send buffers to the root process. In a reduction operation, data elements from corresponding send buffer locations are combined pair-wise by arithmetic or logical operations to yield a single corresponding element in the root process's receive buffer. Application specific reduction operations can be defined at runtime. Parallel communications libraries may support predefined operations. MPI, for example, provides the following pre-defined reduction operations:

| | |
|---|---|
| MPI_MAX | maximum |
| MPI_MIN | minimum |
| MPI_SUM | sum |
| MPI_PROD | product |
| MPI_LAND | logical and |
| MPI_BAND | bitwise and |
| MPI_LOR | logical or |
| MPI_BOR | bitwise or |
| MPI_LXOR | logical exclusive or |
| MPI_BXOR | bitwise exclusive or |

The arrangement of nodes, networks, and I/O devices making up the exemplary system illustrated in FIG. 1 are for explanation only, not for limitation of the present invention. Data processing systems that implement hardware fault diagnosis according to various embodiments of the present invention may include additional nodes, networks, devices, and architectures, not shown in FIG. 1, as will occur to those of skill in the art. The parallel computer (100) in the example of FIG. 1 includes sixteen compute nodes (102); parallel computers implementing hardware fault diagnosis according to embodiments of the present invention sometimes will include thousands of compute nodes. In addition to Ethernet and JTAG, networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

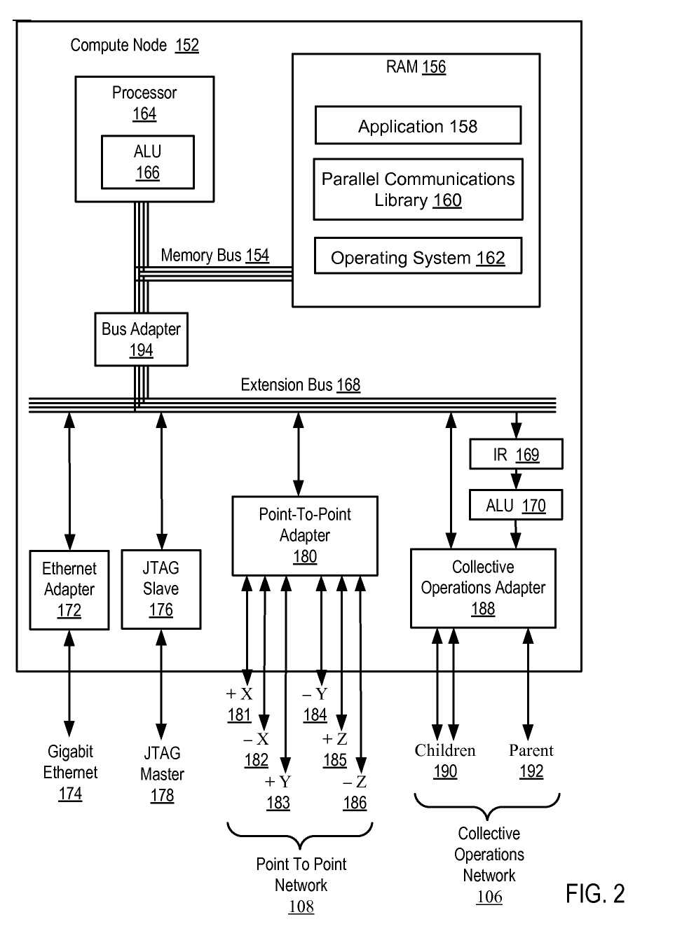

Computer hardware fault diagnosis according to embodiments of the present invention is generally implemented with a parallel computer that includes a plurality of compute nodes. In fact, many such computers include thousands of such compute nodes. Each compute node is in turn itself a kind of computer composed of one or more computer processors, its own computer memory, and its own input/output adapters. For further explanation, therefore, FIG. 2 sets forth a block diagram of an exemplary compute node useful in compute hardware fault diagnosis according to embodiments of the present invention. The compute node (152) of FIG. 2 includes at least one computer processor (164) as well as random access memory (‘RAM’) (156). Processor (164) is connected to RAM (156) through a high-speed memory bus (154) and through a bus adapter (194) and a extension bus (168) to other components of the compute node.

Stored in RAM (156) is an application program (158), a module of computer program instructions, including instructions for collective operations, that carries out parallel, user-level data processing using parallel algorithms. Application program (158) contains computer program instructions that operate, along with other programs on other compute nodes in a parallel computer, to carry out computer hardware fault diagnosis according to embodiments of the present invention by executing a collective operation through a first data communications network upon a plurality of the compute nodes of the computer, executing the same collective operation through a second data communications network upon the same plurality of the compute nodes of the computer, and comparing results of the collective operations.

Also stored RAM (156) is a parallel communications library (160), a library of computer program instructions that carry out parallel communications among compute nodes, including point to point operations as well as collective operations. Application program (158) executes collective operations by calling software routines in parallel communications library (160). A library of parallel communications routines may be developed from scratch for use in hardware fault diagnosis according to embodiments of the present invention, using a traditional programming language such as the C programming language, and using traditional programming methods to write parallel communications routines that send and receive data among nodes on two independent data communications networks. Alternatively, existing prior art libraries may be used. Examples of prior-art parallel communications libraries that may be improved for hardware fault diagnosis according to embodiments of the present invention include the ‘Message Passing Interface’ (‘MPI’) library and the ‘Parallel Virtual Machine’ (‘PVM’) library. PVM was developed by the University of Tennessee, The Oak Ridge National Laboratory and Emory University. MPI is promulgated by the MPI Forum, an open group with representatives from many organizations that define and maintain the MPI standard. MPI at the time of this writing a de facto standard for communication among compute nodes running a parallel program on a distributed memory parallel computer. This specification sometimes uses MPI terminology for ease of explanation, although the use of MPI as such is not a requirement or limitation of the present invention.

Also stored in RAM (156) is an operating system (162), a module of computer program instructions and routines for an application program's access to other resources of the compute node. It is typical for an application program and paralel communications library in a compute node of a parallel computer to run a single thread of execution with no user login and no security issues because the thread is entitled to complete access to all resources of the node. The quantity and complexity of tasks to be performed by an operating system on a compute node in a parallel computer therefore are smaller and less complex than those of an operating system on a serial computer with many threads running simultaneously. In addition, there is no video I/O on the compute node (152) of FIG. 2, another factor that decreases the demands on the operating system. The operating system may therefore be quite lightweight by comparison with operating systems of general purpose computers, a pared down version as it were, or an operating system developed specifically for operations on a particular parallel computer. Operating systems that may usefully be improved, simplified, for use in a compute node include UNIX™, Linux™, Microsoft XP™, AIX™, IBM's i5/OS™, and others as will occur to those of skill in the art.

The exemplary compute node (152) of FIG. 2 includes several communications adapters (172, 176, 180, 188) for implementing data communications with other nodes of a parallel computer. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in systems that diagnose hardware faults according to embodiments of the present invention include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (152) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 includes a JTAG Slave circuit (176) that couples example compute node (152) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 is all three of these: it is one or more integrated circuits installed on a printed circuit board implemented as an embedded system having its own processor, its own memory, and its own I/O capability. JTAG boundary scans through JTAG Slave (176) may efficiently configure processor registers and memory in compute node (152) for use in diagnosing hardware faults according to embodiments of the present invention.

The data communications adapters in the example of FIG. 2 includes a Point To Point Adapter (180) that couples example compute node (152) for data communications to a network (108) that is optimal for point to point message passing operations such as, for example, a network configured as a three-dimensional torus or mesh. Point To Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 includes a Collective Operations Adapter (188) that couples example compute node (152) for data communications to a network (106) that is optimal for collective message passing operations such as, for example, a network configured as a binary tree. Collective Operations Adapter (188) provides data communications through three bidirectional links: two to child nodes (190) and one to a parent node (192).

Example compute node (152) includes two arithmetic logic units (‘ALUs’). ALU (166) is a component of processor (164), and a separate ALU (170) is dedicated to the exclusive use of collective operations adapter (188) for use in performing the arithmetic and logical functions of reduction operations. Computer program instructions of a reduction routine in parallel communications library (160) may latch an instruction for an arithmetic or logical function into instruction register (169). When the arithmetic or logical function of a reduction operation is a ‘sum’ or a ‘logical or,’ for example, collective operations adapter (188) may execute the arithmetic or logical operation by use of ALU (166) in processor (164) or, typically much faster, by use dedicated ALU (170).

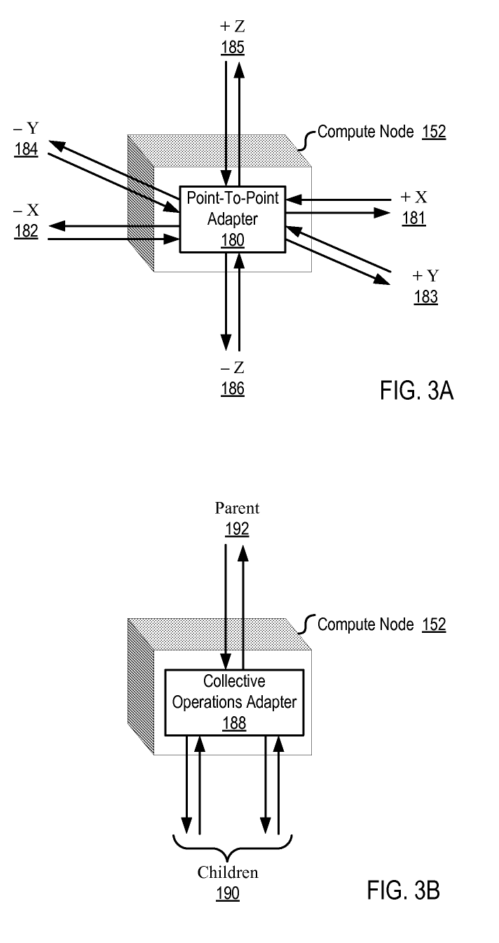

For further explanation, FIG. 3A illustrates an exemplary Point To Point Adapter (180) useful in systems that diagnose hardware faults according to embodiments of the present invention. Point To Point Adapter (180) is designed for use in a data communications network optimized for point to point operations, a network that organizes compute nodes in a three-dimensional torus or mesh. Point To Point Adapter (180) in the example of FIG. 3A provides data communication along an x-axis through four unidirectional data communications links, to and from the next node in the −x direction (182) and to and from the next node in the +x direction (181). Point To Point Adapter (180) also provides data communication along a y-axis through four unidirectional data communications links, to and from the next node in the −y direction (184) and to and from the next node in the +y direction (183). Point To Point Adapter (180) in also provides data communication along a z-axis through four unidirectional data communications links, to and from the next node in the -z direction (186) and to and from the next node in the +z direction (185).

For further explanation, FIG. 3B illustrates an exemplary Collective Operations Adapter (188) useful in systems that diagnose hardware faults according to embodiments of the present invention. Collective Operations Adapter (188) is designed for use in a network optimized for collective operations, a network that organizes compute nodes of a parallel computer in a binary tree. Collective Operations Adapter (188) in the example of FIG. 3B provides data communication to and from two children nodes through four unidirectional data communications links (190). Collective Operations Adapter (188) also provides data communication to and from parent nodes through two unidirectional data communications links (192).

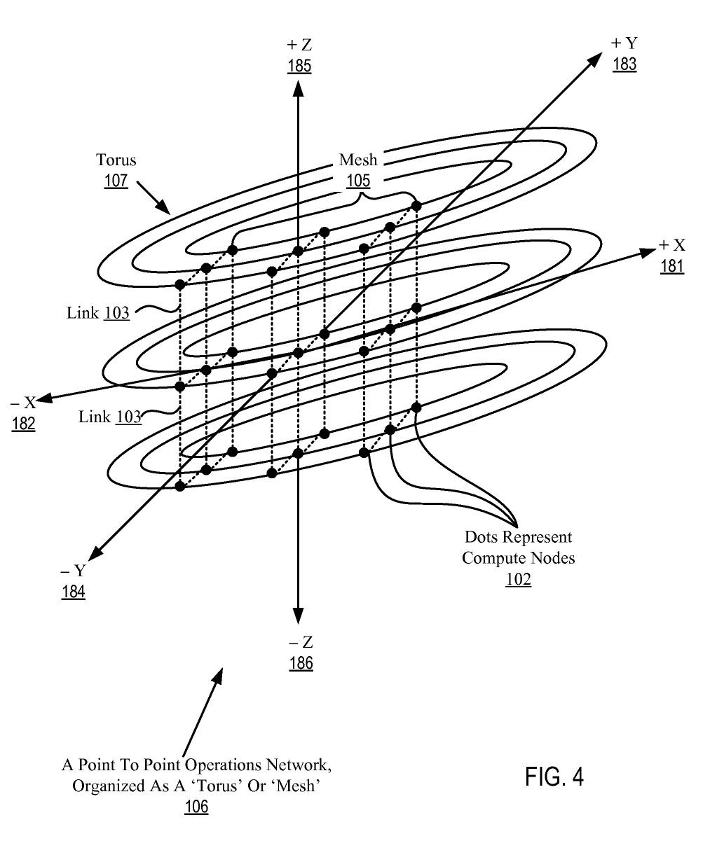

For further explanation, FIG. 4 illustrates an exemplary data communications network optimized for point to point operations (106). In the example of FIG. 4, dots represent compute nodes (102) of a parallel computer, and the dotted lines between the dots represent data communications links between compute nodes. The data communications links are implemented with point to point data communications adapters similar to the one illustrated for example in FIG. 3A, with data communications links on three axes, x, y, and z, and to and from in six directions +x (181), −x (182), +y (183), −y (184), +z (185), and −z (186). The links and compute nodes are organized by this data communications network optimized for point to point operations into a three dimensional mesh (105) that wraps around to form a torus (107). For clarity of explanation, the data communications network of FIG. 4 is illustrated with only 27 compute nodes, but readers will recognize that a data communications network optimized for point to point operations for use in diagnosing computer hardware faults in accordance with embodiments of the present invention may contain only a few compute nodes or may contain thousands of compute nodes.

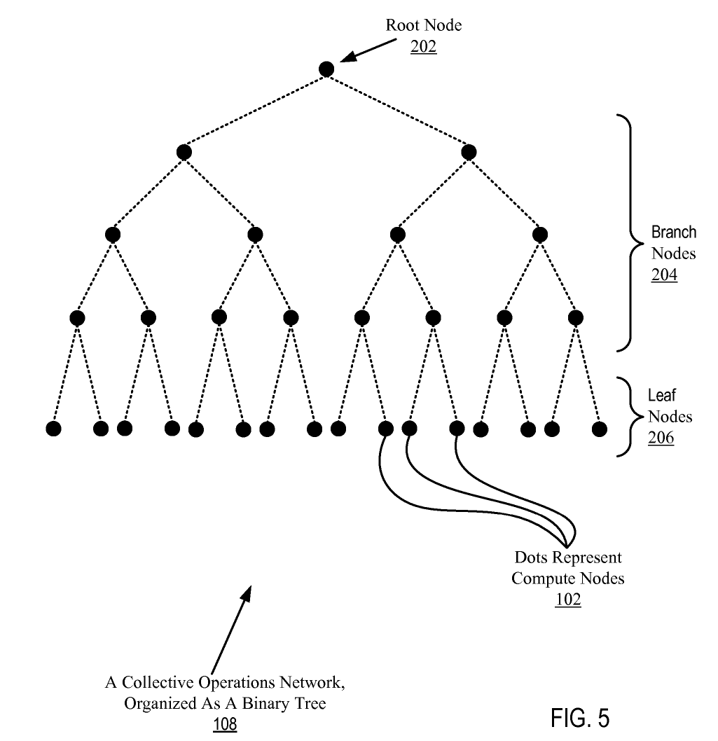

For further explanation, FIG. 5 illustrates an exemplary data communications network optimized for collective operations (108). In the example of FIG. 5, dots represent compute nodes (102) of a parallel computer, and the dotted lines between the dots represent data communications links between compute nodes. The data communications links are implemented with collective operations data communications adapters similar to the one illustrated for example in FIG. 3B, with each node typically providing data communications to and from two child nodes and data communications to and from a parent node, with some exceptions. Nodes in a binary tree may be characterized as a root node (202), branch nodes (204), and leaf nodes (206). The root node (202) has two children but no parent. The leaf nodes (206) each has a parent, but leaf nodes have no children. The branch nodes (204) each has both a parent and two children. The links and compute nodes are thereby organized by this data communications network optimized for collective operations into a binary tree (108). For clarity of explanation, the data communications network of FIG. 5 is illustrated with only 31 compute nodes, but readers will recognize that a data communications network optimized for collective operations for use in diagnosing computer hardware faults in accordance with embodiments of the present invention may contain only a few compute nodes or may contain thousands of compute nodes.

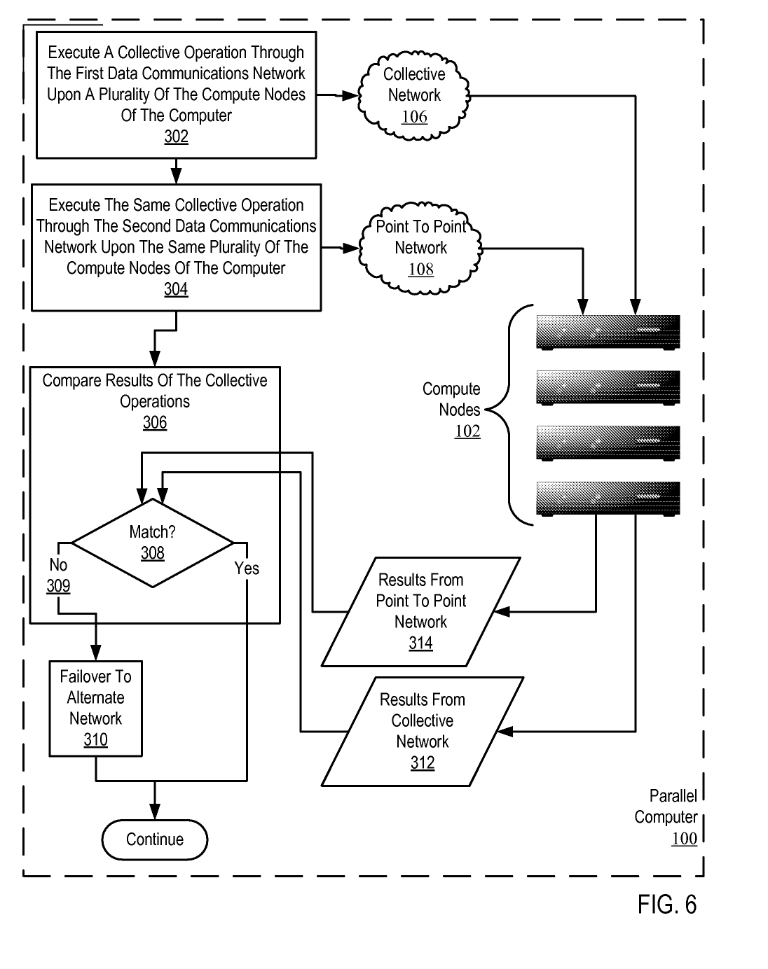

For further explanation, FIG. 6 sets forth a flow chart illustrating an exemplary method of computer hardware fault diagnosis according to embodiments of the present invention. The method is carried out in a parallel computer (100) that includes a plurality of compute nodes (102). The compute nodes are coupled for data communications by at least two independent data communications networks, a first data communications network (106) and a second data communications network (108). The first data communications network (106) may be a network that is optimal for collective operations, such as, for example, the network illustrated and described above with reference to FIG. 4. The first data communications network (106) may be a network that organizes the compute nodes (102) as a tree, such as, for example, the network illustrated and described above with reference to FIG. 4. The second data communications (108) may be a network that is optimal for point to point operations, such as, for example, the network illustrated and described above with reference to FIG. 5. The second data communications network (108) may be a network that organizes the compute nodes as a torus, such as, for example, the network illustrated and described above with reference to FIG. 5. Each data communications network includes data communications links among the compute nodes and data communications adapters within each compute node.

The method of FIG. 6 includes executing (302) a collective operation through the first data communications network (106) upon a plurality of the compute nodes (102) of the computer (100). The collective operation may be any collective operation as may occur to those of skill in the art, broadcast, scatter, gather, reduce, and so on. The method of FIG. 6 also includes executing (304) the same collective operation through the second data communications network (108) upon the same plurality of the compute nodes (102) of the computer (100). Executing the same collective operation twice, once through one data communications network and again through a second data communications network yields two sets of results (312, 314) from the two collective operations. The method of FIG. 6 also includes comparing (306) results (312, 314) of the collective operations. If both collective operations execute correctly, then the results (312, 314) of the two collective operations will match. If one of the collective operations executes incorrectly, then the results (312, 314) of the two collective operations will not match.

In the event that the results (312, 314) of the two collective operations do not match (308, 309), the method of FIG. 6 includes failing over (310) collective operations to an alternate network. The determination that the results of the two collective operations do not match is made in a diagnostic mode, by a diagnostic application. Failing over collective operations to an alternate network means changing to an alternate network for collective operations in normal data processing on the parallel computer until a faulty network can be repaired. If the failing network is a network that is optimal for collective operations, this may mean using a network for collective operations that is not optimized for collective operations. Collective operations may be less efficient. Overall system performance may suffer, but the overall system nevertheless can continue to operate, which is preferable in many circumstances to a complete cessation of operations pending repairs.

Failing over may be accomplished by programming the diagnostic application to set a system flag indicating the need for the failover. Then the software routines that effect collective operations in the parallel communications library may be modified to failover if they find the flag set. This procedure is illustrated by the following segment of pseudocode.

broadcast(void *buf, int count, datatype dtype, ... )
{

int FAILOVER = FALSE;
FAILOVER = getSystemFlag(failover_flag);
barrier( ); /* synchronize the broadcast */
if(FAILOVER) alt_send(void *buf, int count, datatype dtype, ... );
else coll_send void *buf, int count, datatype dtype, ... );

}

This segment is described as pseudocode because it is an explanation expressed in a code-like format, not actual computer program code. The code-like format is similar to the syntax of the C programming language. The broadcast( ) function illustrates an example of a broadcast operation, but the method illustrated here may be applied to any collective operation. This example broadcast( ) function with the line:
FAILOVER=getSystemFlag(failover_flag);
   checks the value of a system level failover flag. The broadcast( ) function then issues a barrier( ) call to synchronize the broadcast operation with broadcast operations that are conducted synchronously with all other compute nodes in a group. If the failover system flag is set, the broadcast( ) function uses an alternative form of the send operation, alt_send( ) to send data through an alternate network, one not optimized for collective operations:
if(FAILOVER) alt_send(void*buf, int count, datatype dtype, . . . );

If the failover system flag is set, the broadcast() function uses coll_send( ) to send data through the system's usual network for collective operations:
else coll_send void*buf, int count, datatype dtype, . . . );

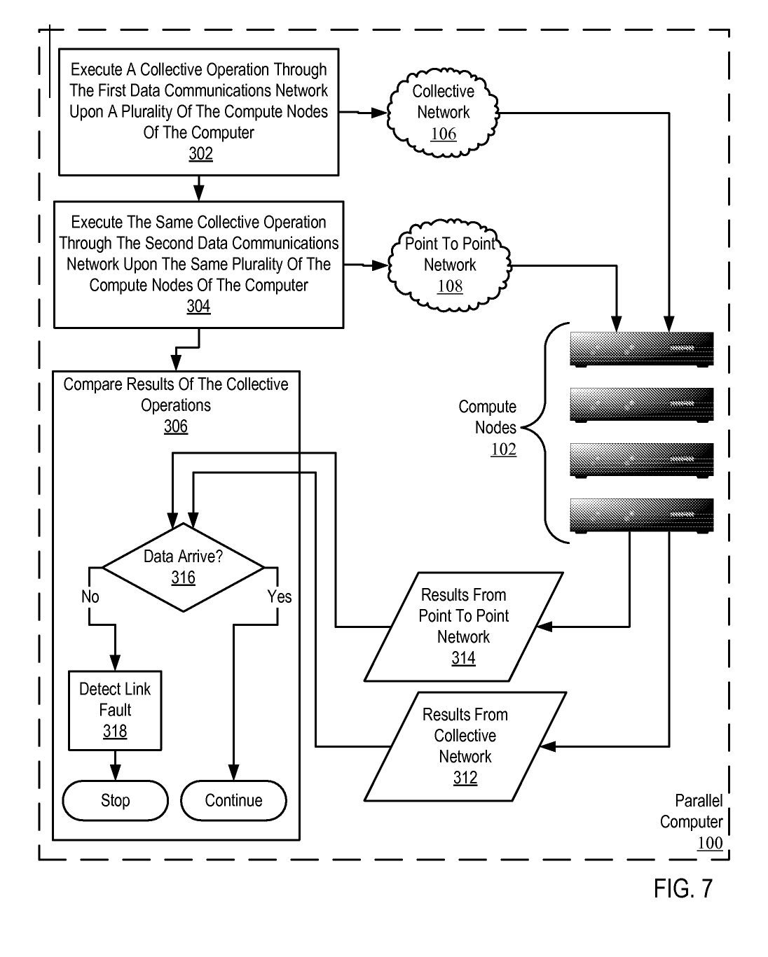

For further explanation, FIG. 7 sets forth a flow chart illustrating a further exemplary method of computer hardware fault diagnosis according to embodiments of the present invention. Like the method of FIG. 6, the method of FIG. 7 is carried out in a parallel computer (100) that includes a plurality of compute nodes (102). The compute nodes are coupled for data communications by at least two independent data communications networks, a first data communications network (106) and a second data communications network (108). The first data communications network (106) may be a network that is optimal for collective operations, such as, for example, the network illustrated and described above with reference to FIG. 4. The first data communications network (106) may be a network that organizes the compute nodes (102) as a tree, such as, for example, the network illustrated and described above with reference to FIG. 4. The second data communications (108) may be a network that is optimal for point to point operations, such as, for example, the network illustrated and described above with reference to FIG. 5. The second data communications network (108) may be a network that organizes the compute nodes as a torus, such as, for example, the network illustrated and described above with reference to FIG. 5. Each data communications network includes data communications links among the compute nodes and data communications adapters within each compute node.

Also like the method of FIG. 6, the method of FIG. 7 includes executing (302) a collective operation through the first data communications network (106) upon a plurality of the compute nodes (102) of the computer (100)—where the collective operation may be any collective operation as may occur to those of skill in the art, broadcast, scatter, gather, reduce, and so on. The method of FIG. 7 also includes executing (304) the same collective operation through the second data communications network (108) upon the same plurality of the compute nodes (102) of the computer (100). Executing the same collective operation twice, once through one data communications network and again through a second data communications network yields two sets of results (312, 314) from the two collective operations.

The method of FIG. 7 also includes comparing (306) results (312, 314) of the collective operations. In the method of FIG. 7, however, the comparing (306) step includes detecting (318) a link fault in dependence upon whether data arrives (316) at a compute node. If, for example, data of a collective operation on the first network never arrives at a compute node, when data of the collective operation on the second network does arrive correctly at the compute node, then the method detects a link fault in the first data communications network. That data never arrives at a compute node may be defined by a timing operation; if a predetermined period times out, the data is defined as not arriving. This method is illustrated by the following segment of pseudocode:

broadcast(buffer, count, datatype, root, ...)
{

if(rootNode)
{

/* send data to children */
send(buffer, count, datatype, child1, ... );
send(buffer, count, datatype, child2, ... );

}
if(branchNode)
{

/* receive data from parent */
recv (buffer, count, datatype, parent, ... );
/* send data to children */
send(buffer, count, datatype, child1, ... );
send(buffer, count, datatype, child2, ... );

}
if(leafNode)
{

/* receive data from parent */
recv (buffer, count, datatype, parent, ... );

}

}
/* definition of receive function*/
recv (buffer, count, datatype, parent, ... );
{

int PDP = 1.0; /* predetermined period (μsec.) */
/* ST = start time */
time ST = get_currrent_time( );
nb_recv(buffer, count, datatype, parent, ...);
while(true)
{

if(nb_recv_test( ) == TRUE) return(successCode);
int CT = get_currrent_time( );
if ((CT − ST) > PDP)
{

report_failure(nodeID, failureType);
return(recvErrorCode);

}

}

}

The broadcast( ) function in this example is a diagnostic broadcast that calls a receive function named recv( ). The recv( ) includes a test for whether data arrives at a compute node, a timeout test. The broadcast function is a collective broadcast operation executed by all compute nodes of a group, what it MPI terminology would be called a ‘communicator.’ Each process executing broadcast( ) in this example determines whether the process is on a root node, a branch node, or a leaf node. The root node has no parent and therefore only sends. The branch nodes have parents and children and therefore both send and receive. The leaf nodes have no children and therefore only receive.

The recv( ) function is configured with a predetermined period of time named ‘PDP’ expiration of which defines receive data not arriving. When recv( ) is called, recv( ) obtains a start time ‘ST’ with:
time ST=get_current_time( );

Recv( ) then calls a non-blocking receive function named nb_recv( ) to carry out the actual receive operation; recv( ) is effectively wrapped around nb_recv( ) so as to incorporate a timeout test. In a while( ) loop, recv( ) tests whether the receive data has yet been received with:
if(nb_recv_test( )==TRUE) return(successCode);

Nb_recv_test( ) returns TRUE if data expected by nb_recv( ) has been received, FALSE otherwise. If the data has not yet been received, recv( ) obtains the current time with:
int CT=get_current_time( );

Recv( ) then calculates the time elapsed since start as CT−ST, and determines whether the time elapsed since start exceeds the predetermined period by:
if ((CT−ST)>PDP).

If the time elapsed since recv( ) started exceeds the predetermined period, recv( ) calls an I/O function named report_failure( ) to report the failure of the receive data to arrive in a compute node and then exits, returning an error code, the value of the error code identifies the error as a failure to receive data.

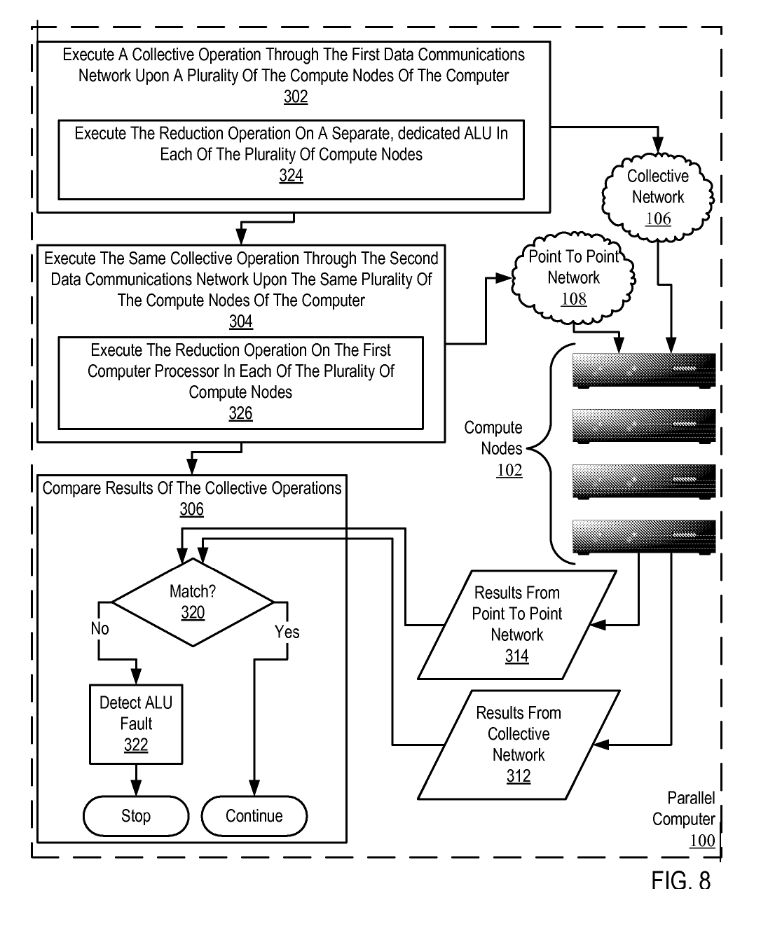

For further explanation, FIG. 8 sets forth a flow chart illustrating a further exemplary method of computer hardware fault diagnosis according to embodiments of the present invention. Like the method of FIG. 6, the method of FIG. 8 is carried out in a parallel computer (100) that includes a plurality of compute nodes (102). The compute nodes are coupled for data communications by at least two independent data communications networks, a first data communications network (106) and a second data communications network (108). The first data communications network (106) may be a network that is optimal for collective operations, such as, for example, the network illustrated and described above with reference to FIG. 4. The first data communications network (106) may be a network that organizes the compute nodes (102) as a tree, such as, for example, the network illustrated and described above with reference to FIG. 4. The second data communications (108) may be a network that is optimal for point to point operations, such as, for example, the network illustrated and described above with reference to FIG. 5. The second data communications network (108) may be a network that organizes the compute nodes as a torus, such as, for example, the network illustrated and described above with reference to FIG. 5. Each data communications network includes data communications links among the compute nodes and data communications adapters within each compute node.

Also like the method of FIG. 6, the method of FIG. 8 includes executing (302) a collective operation through the first data communications network (106) upon a plurality of the compute nodes (102) of the computer (100)—where the collective operation may be any collective operation as may occur to those of skill in the art, broadcast, scatter, gather, reduce, and so on. The method of FIG. 8 also includes executing (304) the same collective operation through the second data communications network (108) upon the same plurality of the compute nodes (102) of the computer (100). Executing the same collective operation twice, once through one data communications network and again through a second data communications network yields two sets of results (312, 314) from the two collective operations.

In the method of FIG. 8, however, each compute node comprises a first computer processor and at least one separate arithmetic-logic unit (‘ALU’) dedicated exclusively to reduction operations in the first network, such as, for examples, processor (164 on FIG. 2) and ALU (170 on FIG. 2) described above with reference to FIG. 2. Also in the method of FIG. 8, rather than just any collective operation, the collective operation is a reduction operation. The reduction operation includes an arithmetic or logical function applied to two data elements in each compute node. All nodes specify the same arithmetic or logical function, and the arithmetic or logical function may be any arithmetic or logical function as may occur to those of skill in the art, maximum, minimum, sum, product, bitwise AND, bitwise OR, and so on.

Also in the method of FIG. 8, executing (302) a collective operation through the first data communications network (106) includes executing (324) the reduction operation on the separate, dedicated ALU (170 on FIG. 2) in each of the plurality of compute nodes. In the method of FIG. 8, executing (304) the same collective operation through the second data communications network (108) includes executing (326) the reduction operation on the first computer processor (164 on FIG. 2) in each of the plurality of compute nodes (102).

In the method of FIG. 8, comparing (306) the results (312, 314) of the collective operations further comprises detecting (322) an ALU fault in dependence upon whether the results (312, 314) of the reduction operations match (320). Consider an example that first runs a non-reduction operation on both networks. The non-reduction operations can be any collective operation except a reduce, that is, a broadcast, a scatter, a gather, and so on. If the results of non-reduce operations match across the two networks, and the results of these two reduction operations do not match, then the mismatch detects an ALU fault. The mismatch detects an ALU fault because the ALUs are in use in the reduction operation, but not in the non-reduction operation.

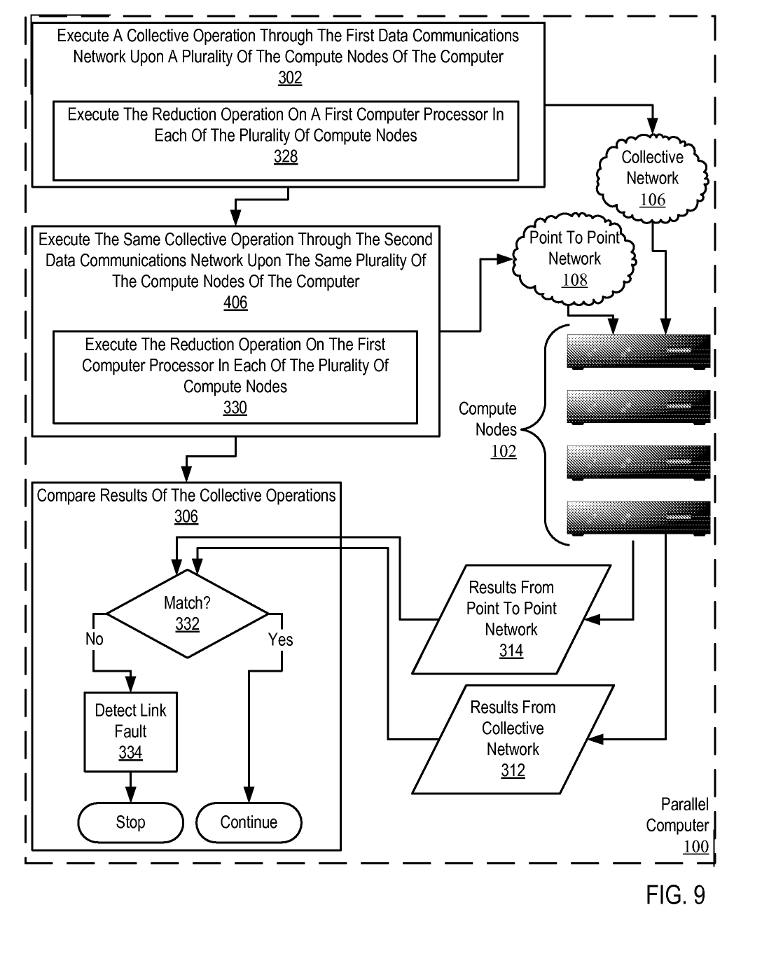

For further explanation, FIG. 9 sets forth a flow chart illustrating a further exemplary method of computer hardware fault diagnosis according to embodiments of the present invention. Like the method of FIG. 8, the method of FIG. 9 is carried out in a parallel computer (100) that includes a plurality of compute nodes (102). The compute nodes are coupled for data communications by at least two independent data communications networks, a first data communications network (106) and a second data communications network (108). The first data communications network (106) may be a network that is optimal for collective operations, such as, for example, the network illustrated and described above with reference to FIG. 4. The first data communications network (106) may be a network that organizes the compute nodes (102) as a tree, such as, for example, the network illustrated and described above with reference to FIG. 4. The second data communications (108) may be a network that is optimal for point to point operations, such as, for example, the network illustrated and described above with reference to FIG. 5. The second data communications network (108) may be a network that organizes the compute nodes as a torus, such as, for example, the network illustrated and described above with reference to FIG. 5. Each data communications network includes data communications links among the compute nodes and data communications adapters within each compute node.

Also like the method of FIG. 8, the method of FIG. 9 includes executing (302) a collective operation through the first data communications network (106) upon a plurality of the compute nodes (102) of the computer (100)—where the collective operation may be any collective operation as may occur to those of skill in the art, broadcast, scatter, gather, reduce, and so on. The method of FIG. 9 also includes executing (304) the same collective operation through the second data communications network (108) upon the same plurality of the compute nodes (102) of the computer (100). Executing the same collective operation twice, once through one data communications network and again through a second data communications network yields two sets of results (312, 314) from the two collective operations.

Also like the method of FIG. 8, in the method of FIG. 9, each compute node comprises a first computer processor and at least one separate arithmetic-logic unit (‘ALU’) dedicated exclusively to reduction operations in the first network, such as, for examples, processor (164 on FIG. 2) and ALU (170 on FIG. 2) described above with reference to FIG. 2. Also in the method of FIG. 9, rather than just any collective operation, the collective operation is a reduction operation. The reduction operation includes an arithmetic or logical function applied to two data elements in each compute node. All nodes specify the same arithmetic or logical function, and the arithmetic or logical function may be any arithmetic or logical function as may occur to those of skill in the art, maximum, minimum, sum, product, bitwise AND, bitwise OR, and so on.

In the method of FIG. 9, however, executing (302) a collective operation through the first data communications network (106) includes executing (328) the reduction operation on the first computer processor (164 on FIG. 2) in each of the plurality of compute nodes (102). In the method of FIG. 9, executing (406) the same collective operation through the second data communications network (108) includes executing (330) the reduction operation on the first computer processor (164 on FIG. 2) in each of the plurality of compute nodes (102).

In the method of FIG. 9, comparing (306) the results (312, 314) of the collective operations further comprises detecting (334) a link fault in dependence upon whether the results (312, 314) of the reduction operations match (332). Consider an example that first runs a reduction operation on both networks, after which the comparison of results fails. The first run uses the main processor's ALU (166 on FIG. 2) in the reduction operation on the point to point network and the dedicated ALU (170 on FIG. 2) in the reduction operation on the collective network. Then according to the method of FIG. 9, the reduction operation is run again—this time using the main processor's ALU (166 on FIG. 2) for both reduction operations on both networks. Now if the results from the point to point network match the results from the collective network, the method detects a fault in a dedicated ALU of the collective network. If the comparison again fails, the method detects a fault in a data communications link.

Exemplary embodiments of the present invention are described largely in the context of a fully functional computer system for computer hardware fault diagnosis. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of computer hardware fault diagnosis,
the method carried out in a parallel computer, the parallel computer comprising a plurality of compute nodes,
the compute nodes coupled for data communications by at least two independent data communications networks including a first data communications network and a second data communications network, each data communications network comprising data communications links among the compute nodes, the method comprising:
executing a collective operation through the first data communications network upon a plurality of the compute nodes of the computer;
executing the same collective operation through the second data communications network upon the same plurality of the compute nodes of the computer; and
comparing results of the collective operations.

2. The method of claim 1 wherein the first data communications network is optimal for collective operations, and the second data communications network is optimal for point to point operations.

3. The method of claim 1 wherein the first data communications network organizes the nodes as a tree, and the second data communications network organizes the nodes as a torus.

4. The method of claim 1 wherein comparing results of the collective operation further comprises detecting a link fault in dependence upon whether data arrives at a compute node.

5. The method of claim 1 wherein:
each compute node comprises a first computer processor and at least one separate arithmetic-logic unit (‘ALU’) dedicated exclusively to reduction operations in the first network,
the collective operation is a reduction operation,
executing a collective operation through the first data communications network includes executing the reduction operation on the separate, dedicated ALU in each of the plurality of compute nodes,
executing the same collective operation through the second data communications network includes executing the reduction operation on the first computer processor in each of the plurality of compute nodes, and
comparing the results of the collective operations further comprises detecting an ALU fault in dependence upon whether the results of the reduction operations match.

6. The method of claim 1 wherein:
each compute node comprises a first computer processor and at least one separate arithmetic-logic unit (‘ALU’) dedicated exclusively to reduction operations in the first network,
the collective operation is a reduction operation,
executing a collective operation through the first data communications network includes executing the reduction operation on the first computer processor in each of the plurality of compute nodes,
executing the same collective operation through the second data communications network includes executing the reduction operation on the first computer processor in each of the plurality of compute nodes, and
comparing the results of the collective operations further comprises detecting a link fault in dependence upon whether the results of the reduction operations match.

7. An apparatus for computer hardware fault diagnosis, the apparatus comprising:
a parallel computer, the parallel computer comprising a plurality of compute nodes, the compute nodes coupled for data communications by at least two independent data communications networks including a first data communications network and a second data communications network, each data communications network comprising data communications links among the compute nodes,
the apparatus further comprising a computer processor, a computer memory operatively coupled to the computer processor, the computer memory having disposed within it computer program instructions capable of:
executing a collective operation through the first data communications network upon a plurality of the compute nodes of the computer;
executing the same collective operation through the second data communications network upon the same plurality of the compute nodes of the computer; and
comparing results of the collective operations.

8. The apparatus of claim 7 wherein the first data communications network is optimal for collective operations, and the second data communications network is optimal for point to point operations.

9. The apparatus of claim 7 wherein the first data communications network organizes the nodes as a tree, and the second data communications network organizes the nodes as a torus.

10. The apparatus of claim 7 wherein comparing results of the collective operation further comprises detecting a link fault in dependence upon whether data arrives at a compute node.

11. The apparatus of claim 7 wherein:
each compute node comprises a first computer processor and at least one separate arithmetic-logic unit (‘ALU’) dedicated exclusively to reduction operations in the first network,
the collective operation is a reduction operation,
executing a collective operation through the first data communications network includes executing the reduction operation on the separate, dedicated ALU in each of the plurality of compute nodes,
executing the same collective operation through the second data communications network includes executing the reduction operation on the first computer processor in each of the plurality of compute nodes, and
comparing the results of the collective operations further comprises detecting an ALU fault in dependence upon whether the results of the reduction operations match.

12. The apparatus of claim 7 wherein:
each compute node comprises a first computer processor and at least one separate arithmetic-logic unit (‘ALU’) dedicated exclusively to reduction operations in the first network,
the collective operation is a reduction operation,
executing a collective operation through the first data communications network includes executing the reduction operation on the first computer processor in each of the plurality of compute nodes,
executing the same collective operation through the second data communications network includes executing the reduction operation on the first computer processor in each of the plurality of compute nodes, and
comparing the results of the collective operations further comprises detecting a link fault in dependence upon whether the results of the reduction operations match.

13. A computer program product for computer hardware fault diagnosis in a parallel computer, the parallel computer comprising a plurality of compute nodes, the compute nodes coupled for data communications by at least two independent data communications networks including a first data communications network and a second data communications network, each data communications network comprising data communications links among the compute nodes, the computer program product disposed upon a signal bearing medium, the computer program product comprising computer program instructions capable of:
executing a collective operation through the first data communications network upon a plurality of the compute nodes of the computer;
executing the same collective operation through the second data communications network upon the same plurality of the compute nodes of the computer; and
comparing results of the collective operations.

14. The computer program product of claim 13 wherein the signal bearing medium comprises a recordable medium.

15. The computer program product of claim 13 wherein the signal bearing medium comprises a transmission medium.

16. The computer program product of claim 13 wherein the first data communications network is optimal for collective operations, and the second data communications network is optimal for point to point operations.

17. The computer program product of claim 13 wherein the first data communications network organizes the nodes as a tree, and the second data communications network organizes the nodes as a torus.

18. The computer program product of claim 13 wherein comparing results of the collective operation further comprises detecting a link fault in dependence upon whether data arrives at a compute node.

19. The computer program product of claim 13 wherein:
each compute node comprises a first computer processor and at least one separate arithmetic-logic unit (‘ALU’) dedicated exclusively to reduction operations in the first network,
the collective operation is a reduction operation,
executing a collective operation through the first data communications network includes executing the reduction operation on the separate, dedicated ALU in each of the plurality of compute nodes,
executing the same collective operation through the second data communications network includes executing the reduction operation on the first computer processor in each of the plurality of compute nodes, and
comparing the results of the collective operations further comprises detecting an ALU fault in dependence upon whether the results of the reduction operations match.

20. The computer program product of claim 13 wherein:
each compute node comprises a first computer processor and at least one separate arithmetic-logic unit (‘ALU’) dedicated exclusively to reduction operations in the first network,
the collective operation is a reduction operation,
executing a collective operation through the first data communications network includes executing the reduction operation on the first computer processor in each of the plurality of compute nodes,
executing the same collective operation through the second data communications network includes executing the reduction operation on the first computer processor in each of the plurality of compute nodes, and
comparing the results of the collective operations further comprises detecting a link fault in dependence upon whether the results of the reduction operations match.
